(19) United States
(12) Patent Application Publication
(10) Pub. No.: US 2007/0164122 A1
(43) Pub. Date: Jul. 19, 2007

(54) CONTACTLESS CARD AND CONTACTLESS CARD SYSTEM

(76) Inventor: Won-Chul Ju, Seoul (KR)

Correspondence Address: Frank Chau, Esq.;F. CHAU & ASSOCIATES, LLC, 130 Woodbury Road, Woodbury, NY, 11797, US

(21) Appl. No.: 11/567,856

(22) Filed: Dec. 7, 2006

(30) Foreign Application Priority Data
Jan. 17, 2006 (KR) 2006-05037

(51) Int. Cl. G06K 19/06

(52) U.S. Cl. 235/492

(57) ABSTRACT

A contactless card including an antenna coil, a resonant capacitor coupled between both end terminals of the antenna, a plurality of capacitors coupled in parallel with the terminals of the antenna correspondingly through switches, a shunt transistor coupled between the terminals of the antenna, forming a bypassing current path, a rectifier coupled between the terminals of the antenna, generating a DC voltage, and a control circuit sensing the DC voltage and controlling a gate voltage of the shunt transistor and on/off conditions of the switches in accordance with the sensed DC voltage.

### CROSS-REFERENCE TO RELATED APPLICATION

This U.S. non-provisional patent application claims priority under 35 U.S.C. § 119 of Korean Patent Application No. 2005-05037 filed on Jan. 17, 2006, the entire contents of which are hereby incorporated by reference.

### BACKGROUND

The present disclosure relates to contactless smart cards, contactless identification devices such as radio frequency identification tags (RFIDs), and contactless identification systems.

Until recently, in the field of systemic identification technology, barcode and magnetic card systems have been widely used for credit cards, public telephone cards, and traffic cards. Such magnetic or barcode identification systems have a problem of degrading a rate of identification over time due to weakening magnetic force, physical damages, or other destructions. Thus, smart cards and radio frequency identification (RFID) tags are increasingly employed as advanced identification systems for overcoming the problems found in conventional systems.

The smart card, which is a so-called IC card, is a kind of plastic card about the size of a credit card having embedded therein an IC chip that is designed to conduct a given transaction and that includes a microprocessor, a card operating system, a security module, and a memory. The smart card is generally distinguished as a contact type, a contactless type, and a combined type in accordance with the manner employed in reading data therefrom.

The RFID tag includes information for identifying an object and is often called a smart tag having a microcomputer chip equipped with an antenna. The RFID tag functions as an identifying body or a memory. The technology for RFID is provided by merging electromagnetic and electrostatic coupling effects in the field of radio frequency (RF) with the electromagnetic spectrum for the purpose of differentiating products, animals, or persons. The RFID tag is currently of interest as a means capable of being a substitute for the barcode system, being convenient in use because there is not need of direct contact or optical scanning in the visual bandwidth.

In a system with the RFID tag, a device or apparatus for writing data in the RFID tag or reading data from the RFID tag is called an identifier or reader.

A contactless identification system, in which the RFID tag or smart card communicates with the reader by way of radio frequency, may be classified into contact, proximity, and vicinity types. According to the specification defined by ISO/IEC 14443, the proximity contactless identification system is operable in the communication range of 0˜10 cm. On the other hand, ISO/IEC 15693 defines the vicinity contactless identification system to be operable in the communication range of 0˜70 cm.

In the proximity/vicinity contactless identification system using a smart card there might be supplied an excessive voltage into the smart card during a proximity operation mode (in 5 cm). Since such an excessive voltage causes damage to a central processor unit or IC chip in the smart card, a technique to block the excessive voltage that is generated during the proximity mode is required.

FIGS. 1A and 1B are graphic diagrams showing amplitude patterns of modulated/demodulated subcarrier signals during the proximity mode of a general contactless card. A conventional solution to this problem uses a shunt transistor to prevent the excessive voltage effect. The contactless card operates the shunt transistor to have a small resistance during the proximity mode, thereby bypassing a current flowing from an antenna coil. In this way, it prevents the excessive voltage, which is induced by the proximity operation, from being supplied into an internal circuit. During the proximity operation mode, however, when the small resistance of the shunt transistor is coupled in parallel with a modulated load resistance portion of an internal transformer, as shown in FIG. 1B. As a result, the intensity of the data signal transferred into an internal demodulator of the card reader becomes lower so as to cause communication errors thereby.

### SUMMARY OF THE INVENTION

Exemplary embodiments of the present invention are directed to a contactless identification device and a system capable of preventing circuit defects and communication errors due to an excessive voltage transferred to a smart card or tag during a proximity operation mode.

According to an exemplary embodiment of the present invention, a contactless card includes an antenna, a resonant capacitor coupled between both terminals of the antenna; pluralities of capacitors coupled in parallel with the terminals of the antenna correspondingly through switches; a shunt transistor coupled between the terminals of the antenna and forming a bypassing current path; a rectifier coupled between the terminals of the antenna and generating a DC voltage, and a control circuit sensing the DC voltage and controlling a gate voltage of the shunt transistor and on/off conditions of the switches in accordance with the senses DC voltage.

In an exemplary embodiment, the contactless card further includes: a nonvolatile memory supplied with the DC voltage; and a digital circuit supplied with the DC voltage, processing data to be transceived through the antenna.

In an exemplary embodiment, the contactless card further includes: a demodulator operating to demodulate data received through the antenna; and a load modulator operating to modulate data to be transmitted.

In an exemplary embodiment, the switches are NMOS transistors.

In an exemplary embodiment, the control circuit includes: a detector determining whether the DC voltage is an excessive voltage; and a selector adjusting the gate voltage of the shunt transistor in accordance with a result from the detector and generating selection signals to turn on/off the switches.

In an exemplary embodiment, the shunt resistor is an NMOS transistor.

In an exemplary embodiment of the present invention, a contactless card system includes: a contactless card; and a card reader communicating with the contactless card in a radio mode. The contactless card includes: a nonvolatile memory; an analogue circuit generating a DC voltage form data transferred in the radio mode; a digital circuit controlling the nonvolatile memory and processing the data transceived to/from the card reader; and a control circuit determining whether the DC voltage generated by the analogue circuit is an excessive voltage.

In an exemplary embodiment the analogue circuit is composed of an antenna; a resonant capacitor coupled between both terminals of the antenna; pluralities of capacitors coupled in parallel with the terminals of the antenna correspondingly through switches; a shunt transistor coupled between the terminals of the antenna, forming a bypassing current path, and a rectifier coupled between the terminals of the antenna, generating a DC voltage. In this case, the control circuit regulates a gate voltage of the shunt transistor and on/off conditions of the switches in accordance with the sensed DC voltage.

In an exemplary embodiment, the analogue circuit further includes: a demodulator operating to demodulate data received through the antenna; and a load modulator operating to modulate data to be transmitted.

In an exemplary embodiment, the control circuit includes: a detector determining whether the DC voltage is an excessive voltage; and a selector adjusting the gate voltage of the shunt transistor in accordance with a result from the detector and generating selection signals to turn on/off the switches.

A further understanding of the nature and advantages of the inventions herein may be realized by reference to the remaining portions of the specification and the attached drawings.

### BRIEF DESCRIPTION OF THE DRAWINGS

Exemplary embodiments of the present invention will be understood in more detail from the following descriptions taken in conjunction with the attached drawings, in which:

FIGS. 1A and 1B are graphic diagrams showing amplitude patterns of modulated/demodulated subcarrier signals during a proximity operation of a general contactless card.

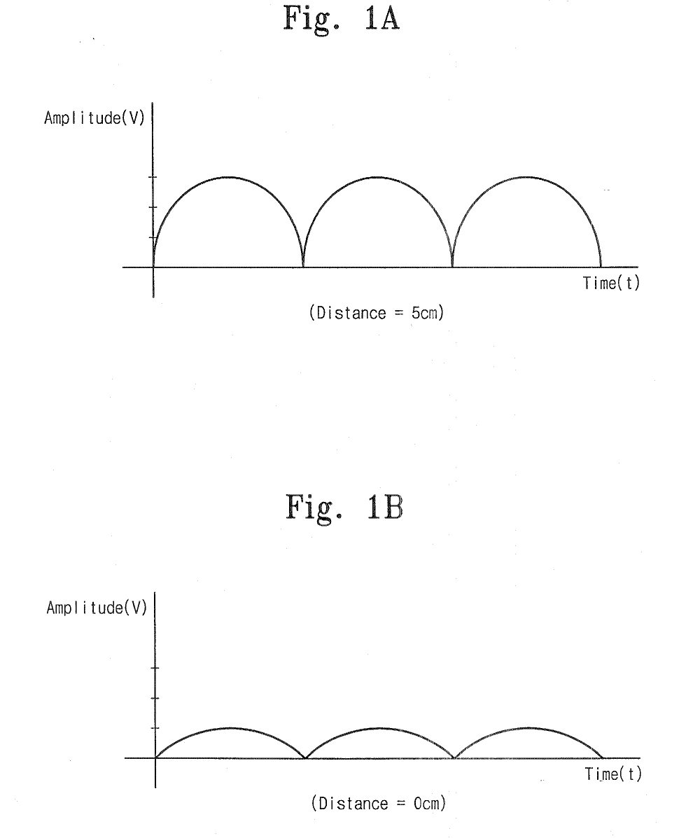

FIG. 2 is a schematic block diagram illustrating a contactless identification system in accordance with an exemplary embodiment of the present invention;

FIG. 3 is a detailed block diagram illustrating the contactless identification system shown in FIG. 2;

FIG. 4 is a circuit diagram illustrating in more detail the contactless identification system shown in FIG. 3; and

FIG. 5 is a circuit diagram illustrating a variable capacitor used in the system shown in FIG. 4 in accordance with an exemplary embodiment of the present invention.

### DETAILED DESCRIPTION OF EXEMPLARY EMBODIMENTS

Exemplary embodiments of the present invention will be described below in more detail with reference to the accompanying drawings. The invention may, however, be embodied in different forms and should not be constructed as limited to the exemplary embodiments set forth herein. Rather, these exemplary embodiments are provided so that this disclosure will be thorough and complete, and will fully convey the scope of the invention to those skilled in the art.

Hereinafter, will be described an exemplary embodiment of the invention in conjunction with the accompanying drawings.

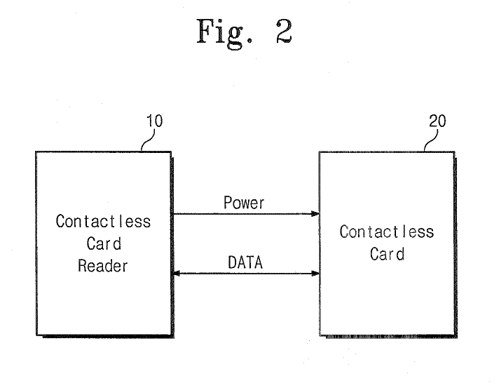

FIG. 2 is a schematic block diagram illustrating a contactless identification system in accordance with an exemplary embodiment of the present invention. Referring to FIG. 2, the contactless identification system is comprised of a contactless card reader 10, and a contactless smart card or tag, hereinafter, referred to as ‘smart card’ 20. The contactless card reader 10 continuously radiates an electronic wave with a constant frequency. Thus, the smart card 20 is powered up by RF when it is close to a frequency range of the contactless card reader 10. Such a kind of smart card 10, which operates with power supplied form the contactless power reader 20, is referred as a ‘passive’ type. Otherwise, a kind of smart card that has its own power is referred as an ‘active’ type. The smart card 20 upon being activated sends a responding signal to the contactless card reader 10 when there is an input command from the contactless card reader 10. During the operation, the contactless card reader 10 interrupts the communication if there is no response form the smart card 20 after a predetermined delay time (defined by ISO/IEC 14446 and ISO/IEC 15693) following the sending of the command.

Because the passive type of contactless smart card 20 conducts an RF signal processing operation with power supplied form the contactless card reader 10, the rate of power supplied is greatly affected by a communication distance from the contactless card reader 10. Therefore, exemplary embodiments of the present invention adopt an advanced contactless identification system, described as follows, in order to overcome the troubles due to variation of power supply rate.

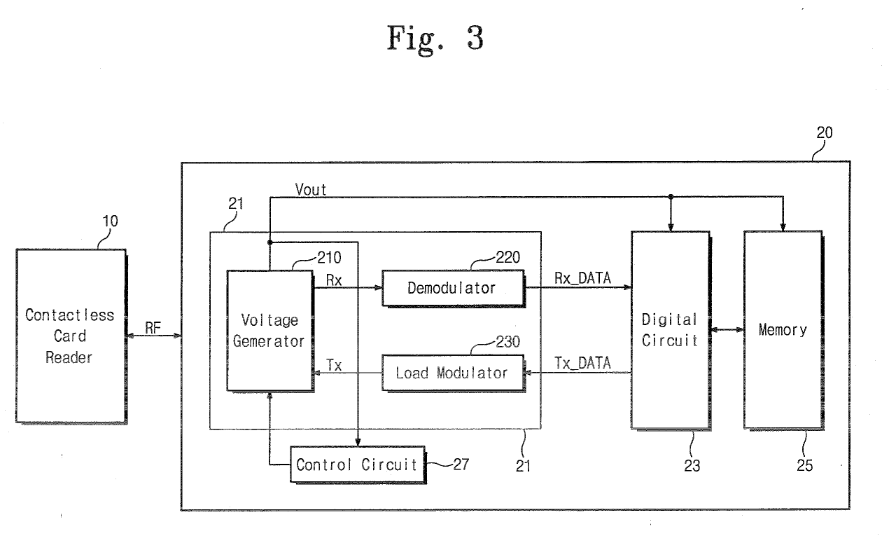

FIG. 3 is a detailed block diagram illustrating the contactless identification system shown in FIG. 2. Referring to FIG. 3, the contactless smart card 20 is comprised of an analogue circuit 21, a digital circuit 23, a memory, for example, a nonvolatile memory, 25, and a control circuit 27. The analogue circuit 21 includes a voltage generator 210, a demodulator 220, and a load modulator 230. The analogue circuit 21 generates a power source voltage at the time of transceiving data by RF signals in a contactless mode. The voltage generator 210 of the analogue circuit 21 generates voltages, which are to be applied to the digital circuit 23 and the memory 25, from RF signals received from the contactless card reader 10. Simultaneously, the demodulator 220 of the analogue circuit 21 provides the digital circuit 23 with reception data that is demodulated from the data contained in subcarrier signals. The load modulator 230 treats data, which is transferred from the digital circuit 23, in a load modulation mode, and then transmits the load-modulated data to the contactless card reader 10.

The digital circuit 23 processes data received from the contactless card reader 10, and includes a receiver, a transmitter, a modulator, and a central processor unit (not shown), and controls data input/output operations into/from the memory 25. Furthermore, the digital circuit 23 first modulates the data and transfers the modulated data to the analogue circuit 21 for transmission.

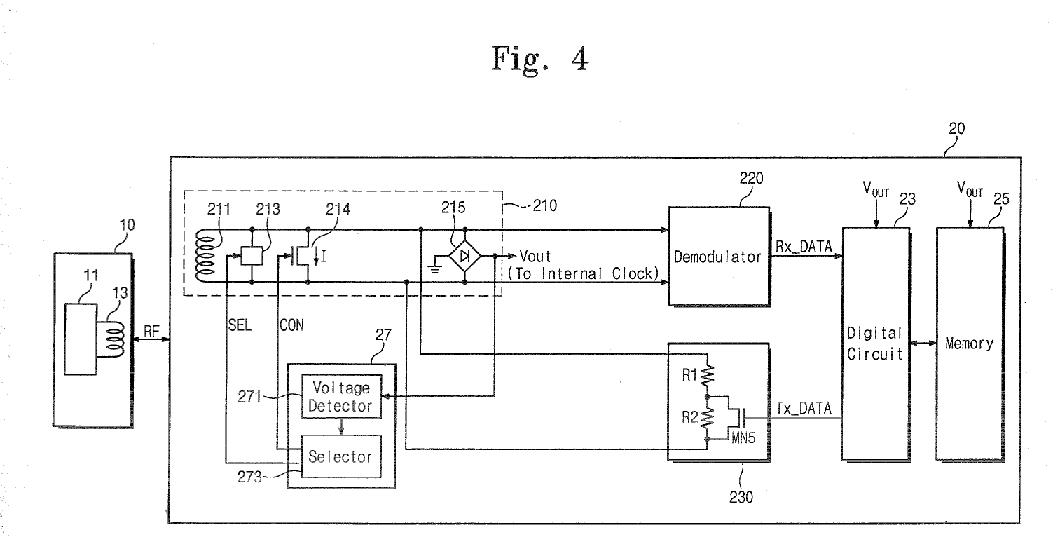

FIG. 4 is a circuit diagram illustrating in more detail the contactless identification system shown in FIG. 3. Referring to FIG. 4, the voltage generator 210 is comprised of an antenna coil 211, a variable capacitor 213, a shunt resistor 214, and a rectifier 215. The variable capacitor 213, the shunt transistor 214, and the rectifier 215 are all coupled in parallel with the two terminals of the antenna 211.

The contactless card reader 10 is comprised of a signal processor 11 and an antenna coil 13 transceiving RF signals. When the contactless smart card 20 accepts the RF signals from the contactless card reader 10, an AC voltage, also called a subcarrier signal, is generated at both terminals of the antenna coil 211. The AC voltage is transformed in to DC voltage through the rectifier 215 and supplied to each internal block of the countless smart card 20 as an output voltage Vout. Data accepted by the contactless smart card 20 from the contactless card reader 10 is contained in AC voltage or subcarrier signal and then is input to the demodulator 220. The demodulator 220 transfers the demodulated reception data Rx_DATA to the digital circuit 23. The digital circuit 23 operates to store the reception data Rx_DATA into the memory 25.

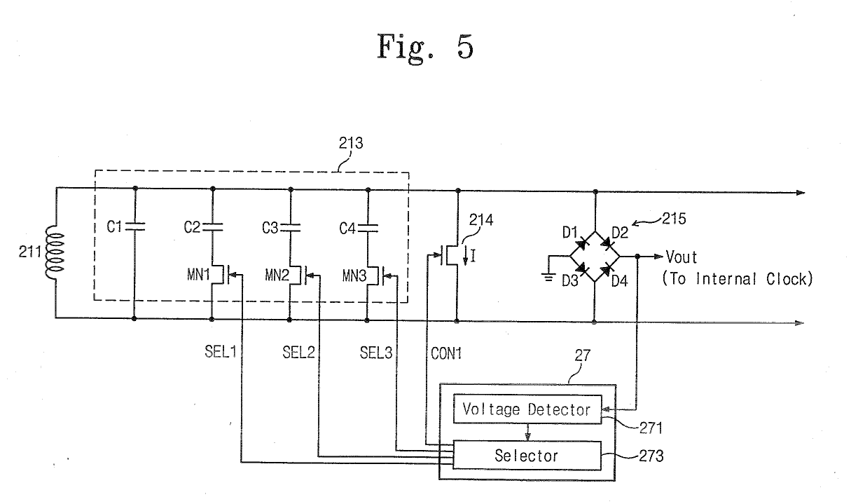

Hereinafter, the features of the resonant circuit 211 and the variable capacitor 213, the shunt transistor 214, and the modulator 230 will be described in detail. FIG. 5 is a circuit diagram illustrating the variable capacitor 213 shown in FIG. 4 according to an exemplary embodiment of the present invention. Generally, a resonant circuit is a unit for passing a signal in a predetermined frequency bandwidth. In an exemplary embodiment of the present invention, the resonant circuit is composed of the antenna coil 211 and the variable capacitor 213. In this contactless identification system, a frequency of the RF signal transmitted from the card reader 10 is defined by the communication protocol, for example, 13.56 MHz as defined by ISO/IEC 14443. A resonant frequency ƒ is established by the parameters that are the inductance L of the antenna coil 211, and the capacitance C of the variable capacitor 213, as follows.

$$f = \frac{1}{2 π \sqrt{LC}} \qquad [ Equation 1 ]$$

As can be seen from Equation 1, the voltage generator 210 can be improved in efficiency when the frequency ƒ of the resonant circuit consisting of the antenna coil 211 and the variable capacitor 213 matches a frequency, for example, 13.56 MHz, of the RF signal provided from the card reader 10. More specifically, this condition assures the highest voltage from the voltage generator 210.

The modulator 230, as illustrated in FIG. 4, is comprised of resistors R1 and R2, and an NMOS transistor MN5 having a current path coupled in parallel with the resistor R2 and a gate coupled to an output from the digital circuit 23. The NMOS transistor MN5 is turned on or off in response to variation of logical level (high or low) in the transmission data Tx_DATA output from the digital circuit 23. According to the on/off condition of the NMOS transistor MN5, the resistance between the antenna coil 211 and the variable capacitor 213 varies to change the amount of current flowing through the antenna coil 211. Thereby, a signal processed by the modulator 230 is transferred to the contactless card reader 10.

The variable capacitor 213, as illustrated in FIG. 5, is comprised of several capacitors C1˜C4 coupled in parallel with both terminals of the antenna coil 211, and NMOS transistors MN1˜MN3 operating as switches coupled in series with each of the capacitors C2˜C4. FIG. 5 shows the three NMOS transistors MN1˜MN3 coupled each to the capacitors C2˜C4, in addition to the antenna coil 211 and the capacitor C1 that may constitute a general resonant circuit. It will be apparent to those skilled in this art that the number of capacitors and transistors is variable based upon design factors for this system.

Gates of the NMOS transistors MN1˜MN3 are supplied with selection signals SEL1˜SEL3 that are output signals from a selector 275 of the control circuit 27. Thus, the capacitors C1˜C4 and the NMOS transistors MN1˜MN3 form the step-type variable capacitor 213, regulated by the control circuit 27. The step-type variable capacitor 213 is convenient in implementing its circuit pattern and alterably adjusting the total capacitance C in Equation 1.

The shunt transistor 214 is coupled in parallel with the step-type variable capacitor 213. A gate of the shunt transistor 214 is coupled to the selector 273, to which a control signal CON1 is applied. The shunt transistor 214 forms a current path bypassing an excessive current caused by an excessive voltage, so as to prevent the generation of excessive voltage during the proximity operation.

If the contactless smart card 20 receives an RF signal from the contactless card reader 10 that is in the proximate distance, for example, within 5 cm, an AC voltage is generated at the antenna coil 211, and the rectifier 215 transforms the AC voltage into a DC voltage as the output voltage Vout. The detector 271 of the control circuit 27 determines the presence of the excessive voltage by comparing the output voltage Vout with a reference voltage. If an excessive voltage has been generated, the selector 273 of the control circuit 27 outputs selections signals SEL1˜SEL3, in response to an output signal from the detector 271, to turn-on/off the transistors MN1˜MN3 of the step-type variable capacitor 213. Thereby, the total capacitance Ctot of the step-type variable capacitor 213 is changed. More specifically, when the selection signal SEL1 is generated with a logically high level, the total capacitance Ctot of the variable capacitor 213 increases to C1+C2. When the selection signals SEL1 and SEL2 are generated with a logically high level, the total capacitance Ctot of the variable capacitor 213 rises up to C1+C2+C3. Because the alteration of the total capacitance Ctot causes the resonant frequency ƒ to vary in accordance with Equation 1, it changes the AC voltage transferred to the rectifier 215. Thus, it is possible to adjust the AC voltage by way of a simple control operation.

At the same time, the selector 273 controls a gate voltage of the shunt transistor 214. According to a rise/fall of the gate voltage, an amount of current 1 flowing through the bypassing current path also increases or decreases. By altering the gage voltage of the shunt transistor 214, it is possible to minutely adjust an amount of the current 1, thereby making voltage variations of the step-type variable capacitor 213 be linear.

Therefore, according to exemplary embodiments of the present invention, even when the contactless smart card 20 is operating in the proximate distance of less than 5 cm in the contactless identification system, it prevents damage to the internal circuits due to the excessive voltage that would be generated by the voltage generator 210. Furthermore, exemplary embodiments of the present invention provide the voltage control by varying the resonant capacitance along with the voltage control provided by the shunt resistor. Thus, during the proximity operation, it is permissible for the resistance of the shunt transistor, which was relatively low, to be maintained higher than the conventional case, assuring the intensity of the subcarrier wave according to the load modulation and hence transferring the effective substrate intensity to the contactless card reader 10. Thereby, the exemplary embodiment solves communication errors that have occurred in the conventional system.

According to exemplary embodiments of the present invention, it is possible to control the output voltage of the voltage generator in a linear form by providing the contactless smart card 20 with the variable capacitor and the shunt transistor that operate a stepping control for capacitance, and the control circuit for regulating the capacitor and transistor. Thus, an excessive voltage during the proximity mode is prevented from being generated, in order to prevent damage to the internal circuits of the contactless smart card.

Moreover, by minutely regulating an amount of the current passing through the shunt transistor, it is possible to minimize degradation in the intensity of the modulated signal by the load modulator by utilizing the resistance of the shunt transistor Thereby, it is possible to lessen communication errors that would be caused by weak modulation signals.

The above-disclosed subject matter is to be considered illustrative, and not restrictive, and the appended claims are intended to cover all such modifications, enhancements, and other embodiments, which fall within the true spirit and scope of the present invention. Thus, to the maximum extend allowed by law, the scope of the present invention is to be determined by the broadest permissible interpretation of the following claims and their equivalents, and shall not be restricted or limited by the foregoing detailed description.

What is claimed is:

1. A contactless card comprising:
an antenna;
a resonant capacitor coupled between end terminals of the antenna;
a plurality of capacitors coupled in parallel with the end terminals of the antenna through a respective plurality of corresponding switches;
a shunt transistor coupled between the end terminals of the antenna and forming a bypassing current path;
a rectifier coupled between the end terminals of the antenna and generating a DC voltage; and
a control circuit sensing the DC voltage and controlling a gate voltage of the shunt transistor and on/off conditions of the switches in accordance with a level of the sensed DC voltage.

2. The contactless card as set forth in claim 1, further comprising:
a nonvolatile memory supplied with the DC voltage; and
a digital circuit supplied with the DC voltage for processing data to be transceived through the antenna.

3. The contactless card as set forth in claim 2, further comprising:
a demodulator operating to demodulate data received through the antenna; and
a load modulator operating to modulate data to be transmitted by the antenna.

4. The contactless card as set forth in claim 1, wherein the switches comprise NMOS transistors.

5. The contactless card as set forth in claim 1, wherein the control circuit comprises:
a detector determining whether the DC voltage is a predetermined excessive voltage; and
a selector adjusting the gate voltage of the shunt transistor in accordance with a result from the detector and generating selection signals to turn on/off the switches.

6. The contactless card as set forth in claim 1, wherein the shunt transistor comprises an NMOS transistor.

7. A contactless card system comprising:
a contactless card; and
a card reader communicating with the contactless card in a radio mode,
wherein the contactless card comprises:
a nonvolatile circuit generating a DC voltage from data transferred in the radio mode;
a digital circuit controlling the nonvolatile memory and processing data transceived to/from the card reader; and
a control circuit determining whether the DC voltage generated by the analogue circuit is a predetermined excessive voltage,
wherein the analogue circuit comprises:
an antenna;
a resonant capacitor coupled between end terminals of the antenna;
a plurality of capacitors coupled in parallel with the end terminals of the antenna through a respective plurality of corresponding switches;
a shunt transistor coupled between the end terminals of the antenna and forming a bypassing current path; and
a rectifier coupled between the end terminals of the antenna and generating the DC voltage;
wherein the control circuit regulates a gate voltage of the shunt transistor and on/off conditions of the plurality of switches in accordance with a level of the determined DC voltage.

8. The contactless card system as set forth in claim 7, wherein the analogue circuit further comprises:
a demodulator operating to demodulate data received through the antenna; and
a load modulator operating to modulate data to be transmitted.

9. The contactless card system as set forth in claim 8, wherein the control circuit comprises:
a detector determining whether the DC voltage is predetermined the excessive voltage; and
a selector adjusting the gate voltage of the shunt transistor in accordance with a result from the detector and generating selection signals to turn on/off the plurality of switches.
